(19) United States
(12) Patent Application Publication
(10) Pub. No.: US 2025/0155830 A1
(43) Pub. Date: May 15, 2025

(54) ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: NORIHIRO KANO, Chiba (JP); MASAYUKI SHINOZUKA, Chiba (JP); EILEEN TAKEUCHI, Tokyo (JP)

(21) Appl. No.: 18/943,241

(22) Filed: Nov. 11, 2024

(30) Foreign Application Priority Data
Nov. 15, 2023 (JP) 2023-194624

(51) Int. Cl. G03G 5/05; G03G 21/18

(52) U.S. Cl. CPC G03G 5/0542; G03G 21/1814

(57) ABSTRACT

An electrophotographic photosensitive member that is excellent in the cleaning property and the durability and has a reduced residual potential. The electrophotographic photosensitive member has a surface layer, wherein the surface layer contains a vinyl resin particle, and the vinyl resin particle is surface-treated with a specific compound.

### BACKGROUND

### Field

The present disclosure relates to an electrophotographic photosensitive member, a process cartridge having the electrophotographic photosensitive member, and an electrophotographic apparatus having the electrophotographic photosensitive member.

### Description of the Related Art

As an electrophotographic photosensitive member to be mounted in an electrophotographic apparatus, an electrophotographic photosensitive member containing an organic photoconductive substance (charge generation substance) is widely used. In recent years, for the purpose of extending the life of the electrophotographic photosensitive member and enhancing an image quality at the time of repeated use, the electrophotographic photosensitive member is required to have enhanced mechanical durability (abrasion resistance).

As a technology for enhancing the abrasion resistance of the electrophotographic photosensitive member, there is a method of causing a surface layer of the electrophotographic photosensitive member to contain a resin particle, and reducing the friction between the surface layer and a contact member such as a cleaning blade. Japanese Patent Application Laid-Open No. H06-332219 discloses a technology of forming a surface layer, by using a dispersion liquid of the fluorine atom-containing resin particle such as a polytetrafluoroethylene resin particle, as a coating liquid for the surface layer.

In addition, in consideration of an influence on the environment, it is desirable that the electrophotographic photosensitive member is formed of a material that is free of a fluorine atom. In Japanese Patent Application Laid-Open No. 2010-14793, a technology is disclosed which reduces friction between a surface layer and a contact member such as a cleaning blade, by using a resin particle which is free of the fluorine atom.

In addition, in Japanese Patent Application Laid-Open No. 2017-58524, a technology is disclosed which improves a cleaning property over a long period of use, by incorporating an organic resin particle containing a styrene structure into the surface layer.

However, according to investigation of the present inventors, in the technology disclosed in Japanese Patent Application Laid-Open No. 2017-58524, a surface layer is obtained that is excellent in a cleaning property and an abrasion resistance, but on the other hand, there has been a case where a residual potential is deteriorated, as compared with the case where the fluorine atom-containing resin particle has been used.

### SUMMARY

Accordingly, an aspect of the present disclosure is to provide an electrophotographic photosensitive member that can reduce the residual potential while maintaining satisfactorily the cleaning property and the abrasion resistance even in the case of the electrophotographic photosensitive member which is free of the fluorine atom.

According to one aspect of the present disclosure, provided is an electrophotographic photosensitive member having a surface layer, wherein the surface layer contains a vinyl resin particle and a charge transport substance, and the vinyl resin particle is surface-treated with at least one selected from the group consisting of: a compound represented by the following formula (A) and (B):

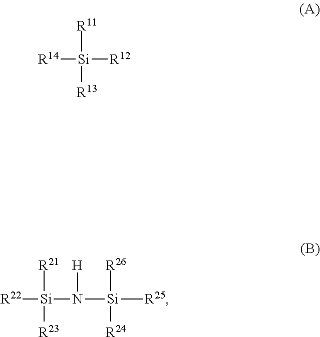

wherein in the formula (A), R¹¹ to R¹⁴ each independently represent an alkyl group, a phenyl group, an alkoxy group or a halogen atom, provided that at least one of R¹¹ to R¹⁴ is an alkoxy group or a halogen atom, and at least one of R¹¹ to R¹⁴ is an alkyl group or a phenyl group; and in the formula (B), R²¹ to R²⁶ each independently represent an alkyl group or a phenyl group.

Furthermore, according to another aspect of the present disclosure, provided is a process cartridge that integrally supports the electrophotographic photosensitive member, and at least one unit selected from the group consisting of a charging unit, a developing unit, and a cleaning unit, and that is freely attachable to and detachable from the main body of the electrophotographic apparatus.

In addition, according to another aspect of the present disclosure, provided is an electrophotographic apparatus including the electrophotographic photosensitive member, a charging unit, an image exposure unit, a developing unit and a transfer unit.

Further features of the present disclosure will become apparent from the following description of exemplary embodiments with reference to the attached drawings.

### BRIEF DESCRIPTION OF THE DRAWINGS

FIG. 1 is a schematic view illustrating one example of a configuration of an electrophotographic photosensitive member of the present disclosure.

FIG. 2 is a view illustrating one example of a polishing machine using a polishing sheet.

FIG. 3 is a view illustrating one example of a schematic configuration of an electrophotographic apparatus having a process cartridge which mounts the electrophotographic photosensitive member thereon.

### DESCRIPTION OF THE EMBODIMENTS

The present disclosure will be described below in detail with reference to preferred embodiments.

As a result of investigation by the present inventors, it has been found that an electrophotographic photosensitive member which is excellent in abrasion resistance and cleaning property in the surface layer, and has a residual potential suppressed can be obtained by incorporating a vinyl resin particle which has been surface-treated with at least one selected from the group consisting of: a compound represented by the following formula (A) and a compound represented by the following formula (B) into the surface layer of the electrophotographic photosensitive member.

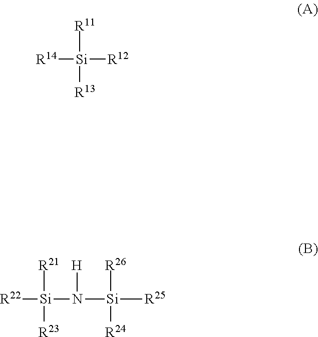

In the formula (A), R¹¹ to R¹⁴ each independently represent an alkyl group, a phenyl group, an alkoxy group or a halogen atom, provided that at least one of R¹¹ to R¹⁴ is an alkoxy group or a halogen atom, and at least one of R¹¹ to R¹⁴ is an alkyl group or a phenyl group.

In the formula (B), R²¹ to R²⁶ each independently represent an alkyl group or a phenyl group.

The present inventors assume the reason why the electrophotographic photosensitive member of the present disclosure is excellent in the abrasion resistance and the cleaning property in the surface layer and is excellent in a suppression effect of the residual potential, in the following way.

An electrophotographic photosensitive member having the surface layer containing an organic resin particle derived from a vinyl bond (hereinafter also referred to as “resin particle having vinyl bond”), such as a styrene structure, has high abrasion resistance and excellent cleaning property, but on the other hand, when having been repeatedly used, a rise of the residual potential occurs. This is considered to be because the resin particle having the vinyl bond partially has a double bond terminal region which is caused by a termination reaction of polymer synthesis on the particle surface, and the region serves as a trap site which causes the rise of the residual potential.

As a result of investigation by the present inventors, it has been found that an electrophotographic photosensitive member which is excellent in the abrasion resistance, the cleaning property and the suppression effect of the residual potential can be obtained by treating the resin particle having the vinyl bond to be contained in the surface layer with a surface treatment agent represented by the above formula (A) and/or (B) to reduce trap sites on the surface of the resin particle having the vinyl bond.

In particular, when at least one of R¹¹ to R¹⁴ in the above formula (A) is set to an alkyl group or a phenyl group, the adsorptivity of the surface treatment agent to the surface of the vinyl resin particle is enhanced, and the surface treatment agent itself can be prevented from serving as the trap site; and it is considered that the suppression effect of the residual potential is thereby sufficiently obtained.

### <Vinyl Resin Particle>

The surface layer of the electrophotographic photosensitive member of the present disclosure contains the vinyl resin particle which is surface-treated with the compound represented by the above formula (A) or (B).

Examples of the resin contained in the vinyl resin particle to be used in the present disclosure include an acrylic resin, a styrene-acrylic resin, a styrene resin, and a polyethylene resin. In addition, it is also preferable to use a particle containing a plurality of types of the above resins. Among the above resins, it is more preferable that the vinyl resin particle according to the present disclosure is of a styrene-acrylic resin, from the viewpoint of sufficiently exhibiting the effect of the present disclosure.

In the cross-sectional observation of the surface layer, it is preferable that an arithmetic average of long diameters of the primary particles (average primary particle size) of the vinyl resin particles is 10 nm or larger and 300 nm or smaller, which are measured on the basis of a secondary electron image obtained by a scanning electron microscope, from the viewpoint of the enhancement of the dispersibility and the suppression of the residual potential.

The average primary particle size of the vinyl resin particles can be measured and calculated by the following method.

### (Method for Measuring Average Primary Particle Size)

The average primary particle size of the vinyl resin particles is measured with the use of a field emission scanning electron microscope (FE-SEM), in the following way. The vinyl resin particles were attached to a commercially available carbon electroconductive tape, the vinyl resin particles which do not attach to the electroconductive tape were removed by compressed air, and platinum vapor deposition was performed. The deposited vinyl resin particle was observed with the use of FE-SEM (S-4700) manufactured by Hitachi High-Tech Corporation. For information, the measurement conditions of FE-SEM are as follows.
Acceleration voltage: 2 kV
WD: 5 mm
Magnification: 20000 times
Number of pixels: 1280 pixels in height and 960 pixels in width (size per pixel: 5 nm)

From the obtained image, the Feret diameters of 100 vinyl resin particles were determined with the use of Image J (open-source software produced by National Institutes of Health (NIH)), and the average value was calculated and determined to be the average primary particle size.

The vinyl resin particles of the present disclosure may be used alone or in combination of two or more types thereof.

### <Surface Treatment Agent>

The vinyl resin particle to be used in the present disclosure is surface-treated with the compound represented by the following formula (A) or (B). From the viewpoint of the residual potential, it is particularly preferable that at least one of R¹¹ to R¹⁴ in the following formula (A) is formed of an alkyl group or a phenyl group.

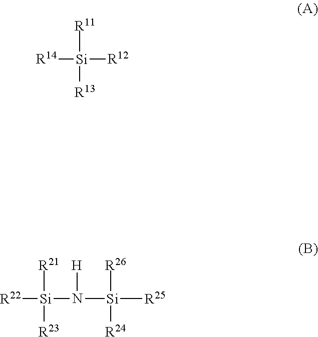

In a ratio between elements in the surface layer, it is preferable that the content of silicon atoms derived from the compound to be used for the surface treatment is 0.0010 atomic % or more and 0.3000 atomic % or less with respect to all atoms in the surface layer. From the viewpoint of crack suppression, it is preferable that the content of the silicon atoms is 0.0010 atomic % or more with respect to all atoms in the surface layer except for a hydrogen atom. In addition, from the viewpoint of the suppression of the residual potential, it is preferable that the content of the silicon atoms is 0.3000 atomic % or less with respect to all atoms in the surface layer except for the hydrogen atom.

### (Method of Measuring Silicon Content)

An elemental analysis of the surface layer is measured with the use of X-ray photoelectron spectroscopic analysis (XPS), in the following way. As a measurement sample, a surface layer piece which has been cut out in four directions of 10 mm is set on a platen dedicated to XPS. Then, in the following XPS apparatus, an X-ray irradiation portion and a sputtering portion by GCIB (gas cluster ion beam) irradiation are set on the above sample portion.

Apparatus used: PHI5000 Versa Probe II manufactured by Ulvac-Phi, Incorporated
Irradiation ray: Al-Kα ray
Beam diameter: 100 μm
Output power: 25 W, 15 kV
Photoelectron capture angle: 45°
Pass Energy: 58.70 eV
Step size: 0.125 eV
XPS peaks: Si2p, N1s, C1s, O1s
Measurement range: 300 μm×200 μm

The Si1 (atomic %) was measured under the above conditions.

Furthermore, sputtering was performed from the outermost surface of the surface layer to a position of a depth of 40 nm, under the following sputtering conditions, and a value measured under the above measurement conditions was defined as Si2 (atomic %).
GUN type: GCIB (gas cluster ion beam)
Sputter Setting: 10 kV

For information, regarding the position of the depth of 40 nm, a sputtering rate (rate of depth with respect to time) was measured in advance, the sputtering time corresponding to the 40 nm was calculated, and the sputtering was performed for the calculated time; and thereby, it was determined that the sputtering was performed to the position of the depth of 40 nm.

### <Electrophotographic Photosensitive Member>

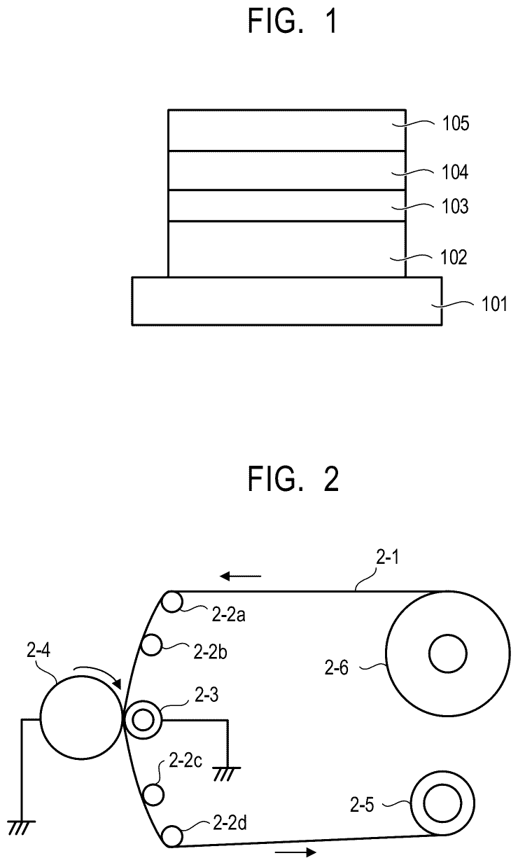

FIG. 1 illustrates one example of a layer structure of the electrophotographic photosensitive member of the present disclosure. In FIG. 1, an undercoat layer 102, a charge generation layer 103, a charge transport layer 104, and a surface layer 105 are layered on a support 101. The photosensitive layer may be configured to be a multilayer type photosensitive layer having a charge generation layer and a charge transport layer, or may be configured to be a single-layer type photosensitive layer containing a charge generation substance and a charge transport substance.

In the present disclosure, the outermost layer of the electrophotographic photosensitive member is defined as the surface layer.

As a method for producing the electrophotographic photosensitive member of the present disclosure, there is a method of preparing a coating liquid of each layer, applying desired layers sequentially, and drying the layers. Examples of the application method of the coating liquid at this time include dip coating, spray coating, inkjet coating, roll coating, die coating, blade coating, curtain coating, wire bar coating, and ring coating. Among the methods, the dip coating is preferable, from the viewpoints of efficiency and productivity.

Each layer will be described below.

### <Support>

It is preferable that the support of the electrophotographic photosensitive member is a member having electroconductivity (electroconductive support). In addition, shapes of the support include a cylindrical shape, a belt shape and a sheet shape. Among the shapes, it is preferable to be the cylindrical support. In addition, the surface of the support may be subjected to electrochemical treatment such as anodization, blast treatment, and cutting treatment.

As a material of the support, a metal, a resin, glass and the like are preferable.

Examples of the metal include aluminum, iron, nickel, copper, gold, stainless steel, and alloys thereof. Among the metals, it is preferable to be an aluminum support using aluminum.

In addition, it is preferable to impart the electroconductivity to the resin or the glass, by treatment such as mixing of or coating with an electroconductive material.

### <Electroconductive Layer>

On the support, an electroconductive layer may be provided. Due to the electroconductive layer being provided, the support can conceal scratches and unevenness on its surface and can control the reflection of light on its surface.

It is preferable that the electroconductive layer contains an electroconductive particle and a binder resin.

Examples of a material of the electroconductive particle include a metal oxide, a metal, and carbon black.

Examples of the metal oxides include zinc oxide, aluminum oxide, indium oxide, silicon oxide, zirconium oxide, tin oxide, titanium oxide, strontium titanate, magnesium oxide, antimony oxide and bismuth oxide. Examples of the metal include aluminum, nickel, iron, nichrome, copper, zinc and silver.

Among these substances, it is preferable to use a metal oxide particle as the electroconductive particle, and is more preferable to use, in particular, a titanium oxide particle, a tin oxide particle and a zinc oxide particle.

When a metal oxide particle is used as the electroconductive particle, the surface of the metal oxide particle may be treated with a silane coupling agent or the like, or the metal oxide particle may be doped with an element such as phosphorus or aluminum, or with an oxide thereof.

In addition, the electroconductive particle may have a multilayer structure having a core material particle and a covering layer which covers the particle. Examples of the core material particle include a titanium oxide particle, a barium sulfate particle and a zinc oxide particle. Examples of the covering layer include a metal oxide particle such as tin oxide.

In addition, when a metal oxide particle is used as the electroconductive particle, it is preferable for a volume-average particle size thereof to be 1 nm or larger and 500 nm or smaller, and is more preferable to be 3 nm or larger and 400 nm or smaller.

Examples of the binder resin include a polyester resin, a polycarbonate resin, a polyvinyl acetal resin, an acrylic resin, a silicone resin, an epoxy resin, a melamine resin, a polyurethane resin, a phenol resin and an alkyd resin.

In addition, the electroconductive layer may further contain a concealing agent such as a silicone oil, a resin particle and titanium oxide.

The electroconductive layer can be formed by preparing a coating liquid for the electroconductive layer, wherein the coating liquid contains each of the above materials and a solvent, forming a coating film of the coating liquid on the support, and drying the coating film. Examples of the solvent to be used for the coating liquid for the electroconductive layer include an alcohol-based solvent, a sulfoxide-based solvent, a ketone-based solvent, an ether-based solvent, an ester-based solvent and an aromatic hydrocarbon-based solvent. Examples of a dispersion method for dispersing the electroconductive particles in the coating liquid for the electroconductive layer include methods which use a paint shaker, a sand mill, a ball mill, and a liquid collision type high-speed dispersion machine, respectively.

It is preferable for an average film thickness of the electroconductive layer to be 1 μm or larger and 50 μm or smaller, and is particularly preferable to be 3 μm or larger and 40 μm or smaller.

### <Undercoat Layer>

In the present disclosure, an undercoat layer may be provided on the support or the electroconductive layer. The undercoat layer which has been provided can thereby enhance an adhesion function between layers and impart a charge injection inhibition function.

It is preferable that the undercoat layer contains a binder resin. In addition, the undercoat layer may be formed as a cured film, by polymerization of a composition containing a monomer having a polymerizable functional group.

Examples of the binder resin include a polyester resin, a polycarbonate resin, a polyvinyl acetal resin, an acrylic resin, an epoxy resin, a melamine resin, a polyurethane resin, a phenol resin, and a polyvinyl phenol resin, an alkyd resin, a polyvinyl alcohol resin, a polyethylene oxide resin, a polypropylene oxide resin, a polyamide resin, a polyamide acid resin, a polyimide resin, a polyamide-imide resin and a cellulose resin.

Examples of the polymerizable functional group which the monomer having a polymerizable functional group has include an isocyanate group, a block isocyanate group, a methylol group, an alkylated methylol group, an epoxy group, a metal alkoxide group, a hydroxy group, an amino group, a carboxyl group, a thiol group, a carboxylic acid anhydride group, and a carbon-carbon double bond group.

The undercoat layer may further contain an electron transport substance, a metal oxide particle, a metal particle, an electroconductive polymer or the like, for the purpose of enhancing electric characteristics. Among these substances, it is preferable to use an electron transport substance and a metal oxide particle.

Examples of the electron transport substance include a quinone compound, an imide compound, a benzimidazole compound, a cyclopentadienylidene compound, a fluorenone compound, a xanthone compound, a benzophenone compound, a cyano vinyl compound, an aryl halide compound, a silole compound, and a boron-containing compound. The undercoat layer may be formed as a cured film, by using an electron transport substance having a polymerizable functional group as an electron transport substance, and copolymerizing the electron transport substance with the above monomer having the polymerizable functional group.

Examples of the metal oxide particle include particles of indium tin oxide, tin oxide, indium oxide, titanium oxide, strontium titanate, zinc oxide and aluminum oxide. A particle of silicon dioxide can also be used. Examples of the metal particle include particles of gold, silver and aluminum.

The metal oxide particle contained in the undercoat layer may be subjected to surface treatment with the use of a surface treatment agent such as a silane coupling agent, and be used.

As a method of surface-treating the metal oxide particle, a general method is used. Examples thereof include a dry method and a wet method.

The dry method is a method involving adding an aqueous alcohol solution, an organic solvent solution or an aqueous solution containing the surface treatment agent, to the metal oxide particles being stirred in a high-speed stirrable mixer such as a Henschel mixer, followed by uniform dispersion and then drying.

In addition, the wet method is a method of dispersing a metal oxide particle and the surface treatment agent in a solvent, by stirring or by a sand mill using glass beads or the like, and after the dispersion, removing the solvent by filtration or distillation under reduced pressure. After removal of the solvent, it is preferable to further perform baking at 100° C. or higher.

The undercoat layer may further contain an additive agent. For example, known materials can be contained therein, which include metal particles such as an aluminum particle; electroconductive substance particles such as carbon black; charge transport substances; metal chelate compounds; and organometallic compounds.

The undercoat layer can be formed by preparing a coating liquid for the undercoat layer, wherein the coating liquid contains each of the above materials and a solvent, forming this coating film on the support or the electroconductive layer, and drying and/or curing the coating film.

Examples of the solvent which is used in the coating liquid for the undercoat layer include organic solvents such as an alcohol, a sulfoxide, a ketone, an ether, an ester, an aliphatic halogenated hydrocarbon, and an aromatic compound. In the present disclosure, it is preferable to use an alcohol-based or ketone-based solvent.

Examples of a dispersion method for preparing the coating liquid for the undercoat layer include methods with the use of a homogenizer, an ultrasonic dispersing machine, a ball mill, a sand mill, a roll mill, a vibration mill, an attritor, and a liquid collision type high-speed dispersing machine.

It is preferable for an average film thickness of the undercoat layer to be 0.1 μm or larger and 50 μm or smaller, is more preferable to be 0.2 μm or larger and 40 μm or smaller, and is particularly preferable to be 0.3 μm or larger and 30 μm or smaller.

### <Photosensitive Layer>

The photosensitive layer of the electrophotographic photosensitive member is mainly classified into (1) a multilayer type photosensitive layer and (2) a single-layer type photosensitive layer. (1) A multilayer type photosensitive layer is a photosensitive layer which includes a charge generation layer containing a charge generation substance, and a charge transport layer containing a charge transport substance. (2) A single-layer type photosensitive layer is a photosensitive layer containing both a charge generation substance and a charge transport substance.

### (1) Multilayer Type Photosensitive Layer

The multilayer type photosensitive layer includes a charge generation layer and a charge transport layer.

### (1-1) Charge Generation Layer

It is preferable that the charge generation layer contains a charge generation substance and a binder resin.

Examples of the charge generation substance include an azo pigment, a perylene pigment, a polycyclic quinone pigment, an indigo pigment and a phthalocyanine pigment. Among these pigments, the azo pigment and the phthalocyanine pigment are preferable. Among the phthalocyanine pigments, an oxytitanium phthalocyanine pigment, a chlorogallium phthalocyanine pigment and a hydroxygallium phthalocyanine pigment are preferable.

It is preferable for a content of the charge generation substance in the charge generation layer to be 40% by mass or more and 85% by mass or less, and is more preferable to be 60% by mass or more and 80% by mass or less, with respect to the total mass of the charge generation layer.

Examples of the binder resin include a polyester resin, a polycarbonate resin, a polyvinyl acetal resin, a polyvinyl butyral resin, an acrylic resin, a silicone resin, an epoxy resin, a melamine resin, a polyurethane resin, a phenol resin, a polyvinyl alcohol resin, a cellulose resin, a polystyrene resin, a polyvinyl acetate resin and a polyvinyl chloride resin. Among these resins, the polyvinyl butyral resin is more preferable.

In addition, the charge generation layer may further contain an additive agent such as an antioxidizing agent and an ultraviolet absorbing agent. Specific examples thereof include a hindered phenol compound, a hindered amine compound, a sulfur compound, a phosphorus compound and a benzophenone compound.

The charge generation layer can be formed by preparing a coating liquid for the charge generation layer, wherein the coating liquid contains each of the above materials and a solvent, forming this coating film on the undercoat layer, and drying the coating film. Examples of the solvent to be used for the coating liquid include an alcohol-based solvent, a sulfoxide-based solvent, a ketone-based solvent, an ether-based solvent, an ester-based solvent, and an aromatic hydrocarbon-based solvent.

It is preferable for an average film thickness of the charge generation layer to be 0.1 μm or larger and 1 μm or smaller, and is more preferable to be 0.15 μm or larger and 0.4 μm or smaller.

### (1-2) Charge Transport Layer

It is preferable that the charge transport layer contains a charge transport substance and a binder material.

When a protective layer which will be described later is not provided, the charge transport layer becomes the surface layer of the electrophotographic photosensitive member. In this case, the charge transport layer contains the vinyl resin particle which has been surface-treated with the compound represented by the above formula (A) and/or (B), the binder resin, and the charge transport substance.

Examples of the charge transport substance include a polycyclic aromatic compound, a heterocyclic compound, a hydrazone compound, a styryl compound, an enamine compound, a triarylamine compound, and resins having a group derived from these substances.

Among these materials, it is preferable that the charge transport substance has a structure of the following formula (C):

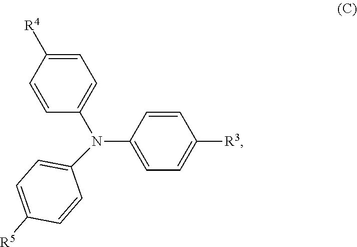

wherein R¹ and R² are each independently a hydrogen atom or a methyl group, and R³ is a linear or branched alkyl group having 1 to 5 carbon atoms, a methacryloyloxy group, or an acryloyloxy group.

It is preferable for a content of the charge transport substance in the charge transport layer to be 25% by mass or more and 70% by mass or less, and is more preferable to be 30% by mass or more and 55% by mass or less, with respect to a total mass of the charge transport layer.

Examples of the binder resin include a polycarbonate resin, a polyarylate resin, an acrylic resin and a polystyrene resin. Among these resins, thermoplastic resins are preferable, and in particular, the polycarbonate resin and the polyarylate resin are preferable.

A content ratio (mass ratio) of the charge transport substance to the resin is preferably 4:10 to 20:10, and is more preferably 5:10 to 12:10.

It is preferable that a content of the surface-treated vinyl resin particle in the charge transport layer is 1% by mass or more and 30% by mass or less.

In addition, the charge transport layer may contain an additive agent such as an antioxidizing agent, an ultraviolet absorbing agent, a plasticizing agent, a leveling agent and a lubricant. The specific additive agents include a hindered phenol compound, a hindered amine compound, a sulfur compound, a phosphorus compound, a benzophenone compound, a siloxane modified resin, silicone oil, a polystyrene resin particle, a polyethylene resin particle, a boron nitride particle and a fluororesin particle.

The charge transport layer can be formed by preparing a coating liquid for the charge transport layer, wherein the coating liquid contains each of the above materials and a solvent, forming this coating film on the charge generation layer, and drying the coating film. Examples of the solvent to be used for the coating liquid include an alcohol-based solvent, a ketone-based solvent, an ether-based solvent, an ester-based solvent, and an aromatic hydrocarbon-based solvent. Among these solvents, the ether-based solvent or the aromatic hydrocarbon-based solvent is preferable.

It is preferable for an average film thickness of the charge transport layer to be 5 μm or larger and 50 μm or smaller, and is particularly preferable to be 35 μm or larger and 50 μm or smaller.

### (2) Single-Layer Type Photosensitive Layer

The single-layer type photosensitive layer can be formed by preparing a coating liquid for the photosensitive layer, wherein the coating liquid contains the charge generation substance, the charge transport substance, a resin and a solvent, forming this coating film on the undercoat layer, and drying the coating film. The charge generation substance, the charge transport substance and the resin are the same as the examples of the materials in the above “(1) multilayer type photosensitive layer”.

It is preferable for an average film thickness of the single-layer type of photosensitive layer to be 5 μm or larger and 50 μm or smaller, and is particularly preferable to be 35 μm or larger and 50 μm or smaller.

### <Protective Layer>

In the present disclosure, a protective layer may be provided on the photosensitive layer. Due to the protective layer provided therein, the electrophotographic photosensitive member can enhance its durability.

When the protective layer is provided, the protective layer becomes the surface layer of the electrophotographic photosensitive member. In this case, the protective layer contains the surface-treated vinyl resin particle and the binder material.

The protective layer may be formed also as a cured film, by the polymerization of a composition which becomes a raw material of the binder material, and contains, for example, a monomer having a polymerizable functional group. Examples of a reaction at this time include a thermal polymerization reaction, a photopolymerization reaction, and a radiation-induced polymerization reaction. Examples of the polymerizable functional group which the monomer having a polymerizable functional group has include an isocyanate group, a block isocyanate group, a methylol group, an alkylmethylol group, an epoxy group, a metal alkoxyl group, a hydroxy group, an amino group, a carboxyl group, a thiol group, a carboxylic acid anhydride group, and a group containing a carbon-carbon double bond. Examples of the group containing the carbon-carbon double bond include an acryloyl group and a methacryloyl group. As a monomer having the polymerizable functional group, a monomer having charge transporting capability may be used.

Here, a cured product of the monomer having the polymerizable functional group is the binder material of the protective layer. Specifically, in the present disclosure, the surface layer contains the binder material, or at least one selected from the binder material and a raw material of the binder material.

As the monomer having the polymerizable functional group, it is preferable to use a charge transporting compound having a chain polymerizable functional group.

It is preferable for the charge transporting compound having the chain polymerizable functional group to have a structure of the following formula (D). It is preferable for the surface layer according to the present disclosure to be the case of a polymer containing a compound represented by the following formula (D), from the viewpoint of the durability and the cleaning property.

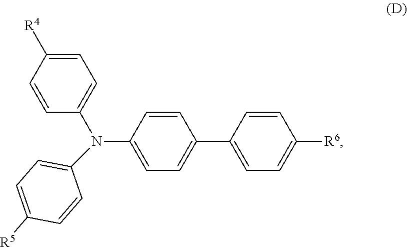

wherein R⁴ and R⁵ are each independently a hydrogen atom or a methyl group, and R⁶ is a methacryloyloxy group or an acryloyloxy group.

It is preferable for a content of the surface-treated vinyl resin particles in the surface layer (protective layer) to be 1% by mass or more and 30% by mass or less, with respect to the total mass of the whole surface layer (protective layer).

The protective layer may contain an additive agent such as an antioxidizing agent, an ultraviolet absorbing agent, a plasticizing agent and a leveling agent. Specific examples include a hindered phenol compound, a hindered amine compound, a sulfur compound, a phosphorus compound, a benzophenone compound, a siloxane modified resin and a silicone oil.

The protective layer can be formed by preparing a coating liquid for the protective layer that contains each of the above materials and a solvent, forming a coating film of the coating liquid on the photosensitive layer, and drying and/or curing the coating film. Examples of the solvent to be used for the coating liquid include an alcohol-based solvent, a ketone-based solvent, an ether-based solvent, a sulfoxide-based solvent, an ester-based solvent, and an aromatic hydrocarbon-based solvent.

It is preferable for a film thickness of the protective layer to be 0.50 μm or larger and 10 μm or smaller, and is more preferable to be 1 μm or larger and 7 μm or smaller.

### <Surface Working of Electrophotographic Photosensitive Member>

In the present disclosure, the surface of the electrophotographic photosensitive member may be worked. Due to the surface being worked, the electrophotographic photosensitive member can further stabilize a behavior of a cleaning unit (cleaning blade) which is brought into contact with itself. Examples of the surface working method include: a method of pressing a mold having salient portions against the surface of the electrophotographic photosensitive member, and transferring the shape; a method of giving an uneven shape by mechanical polishing; and a method of roughening the surface of the electrophotographic photosensitive member by causing a powder to collide with the surface. The salient portions or the recess portions which are provided on the surface layer of the electrophotographic photosensitive member in this way can further stabilize the behavior of the cleaning unit which is brought into contact with the electrophotographic photosensitive member.

The above recess portions or the salient portions may be formed on the whole surface of the electrophotographic photosensitive member, or may be formed on one part of the surface of the electrophotographic photosensitive member. When the recess portions or salient portions are formed on a part of the surface of the electrophotographic photosensitive member, it is preferable that the recess portions or the salient portions are formed at least on the whole contact area with the cleaning unit (cleaning blade).

When the recess portions are formed, the recess portions can be formed on the surface of the electrophotographic photosensitive member by pressing the mold having salient portions corresponding to the recess portions, against the surface of the electrophotographic photosensitive member and transferring the shape.

### <Polishing Tool to be Used for Mechanical Polishing>

The mechanical polishing can employ a known unit. Generally, the surface of the electrophotographic photosensitive member is polished by bringing a polishing tool into contact with the electrophotographic photosensitive member, and relatively moving any one or both of the tool and the member. The polishing tool is a polishing member in which the layer is provided on a base material, in which polishing abrasive grains are dispersed in a binder resin.

Examples of the abrasive grains include particles of aluminum oxide, chromium oxide, diamond, iron oxide, cerium oxide, corundum, calcite, silicon nitride, boron nitride, molybdenum carbide, silicon carbide, tungsten carbide, titanium carbide and silicon oxide. It is preferable for a particle size of the abrasive grain to be 0.01 μm or larger and 50 μm or smaller, and is more preferable to be 1 μm or larger and 15 μm or smaller. When the particle size of the abrasive grain is too small, a polishing force becomes weak, and an F/C ratio that is a molar fraction ratio of a fluorine atom F to a carbon atom C by X-ray photoelectron spectroscopy of the surface layer, on the outermost surface of the electrophotographic photosensitive member, is difficult to be increased. These abrasive grains may be used alone or in a mixed form of two or more types thereof. When two or more types are mixed, the materials and particle sizes may be different or the same.

The binder resin for dispersing the abrasive grains therein which are used in the polishing tool can employ known thermoplastic resins, thermosetting resins, reactive type resins, electron beam curing resins, ultraviolet curing resins, visible light curing resins, and antifungal resins. Examples of the thermoplastic resins include a vinyl chloride resin, a polyamide resin, a polyester resin, a polycarbonate resin, an amino resin, a styrene-butadiene copolymer, a urethane elastomer and a polyamide-silicone resin. Examples of the thermosetting resins include a phenol resin, a phenoxy resin, an epoxy resin, a polyurethane resin, a polyester resin, a silicone resin, a melamine resin and an alkyd resin. In addition, an isocyanate-based curing agent may be added to the thermoplastic resin.

It is preferable that a film thickness of a layer obtained by dispersing abrasive grains in the binder resin of the polishing tool is 1 μm or larger and 100 μm or smaller. If the film thickness is too thick the film thickness tends to easily become uneven, and as a result, the unevenness of the surface roughness of an object to be polished becomes a problem. On the other hand, if the film thickness is too thin, the abrasive grains tend to easily fall off.

The shape of the base material of the polishing tool is not particularly limited. In Examples of the present disclosure, a sheet-shaped base material has been used so that the cylindrical electrophotographic photosensitive member is efficiently polished, but other shapes may be used (Hereinafter, the polishing tool of the present disclosure is also referred to as a “polishing sheet”). The material of the base material of the polishing tool is not also particularly limited. Examples of the material of the sheet-shaped base material include paper, woven fabric, nonwoven fabric and plastic film.

The polishing tool can be obtained by applying a paint in which the above abrasive grains, the binder resin and a solvent that can dissolve the binder resin are mixed and dispersed, onto the base material, and drying the paint.

### <Polishing Apparatus>

FIG. 2 illustrates one example of a polishing apparatus for an electrophotographic photosensitive member of the present disclosure.

FIG. 2 illustrates an apparatus for polishing a cylindrical electrophotographic photosensitive member, with the use of a polishing sheet. In FIG. 2, a polishing sheet 2-1 is wound around a hollow shaft 2-6, and a motor (not illustrated) is arranged to the shaft 2-6 so that a tension is given to the polishing sheet 2-1 in a direction opposite to a direction in which the polishing sheet 2-1 is fed. The polishing sheet 2-1 is fed in the arrow direction, passes through a backup roller 2-3 via guide rollers 2-2a and 2-2b, and the polishing sheet 2-1 after polishing is wound by a winding unit 2-5 by a motor (not illustrated) via guide rollers 2-2c and 2-2d. When polishing is performed, the polishing sheet 2-1 is always pressed against an object to be treated (electrophotographic photosensitive member before being polished) 2-4. The polishing sheet 2-1 has an insulating property in many cases, and accordingly, it is preferable to use a material which is grounded or has electroconductivity, at portions in contact with the polishing sheet 2-1.

A feed speed of the polishing sheet 2-1 is preferably in a range of 10 to 1000 mm/min. When a feed amount is small, the binder resin adheres to the surface of the polishing sheet 2-1, and a deep damage is formed on the surface of the object 2-4 to be treated due to the adhesion, in some cases.

The object 2-4 to be treated is placed at a position opposed to the backup roller 2-3 through the polishing sheet 2-1. It is preferable that the backup roller 2-3 is an elastic body, from the viewpoint of enhancing the uniformity of the surface roughness of the object 2-4 to be treated. At this time, the object 2-4 to be treated and the backup roller 2-3 are pressed against each other at a desired set value for a predetermined period of time through the polishing sheet 2-1, and the surface of the object 2-4 to be treated is polished. A rotation direction of the object 2-4 to be treated may be the same as or opposite to the direction in which the polishing sheet 2-1 is fed. In addition, the rotation direction may be changed during the polishing.

The pressing pressure of the backup roller 2-3 against the object 2-4 to be treated depends on the hardness of the backup roller 2-3 and the polishing period of time, but is preferably 0.005 to 15 N/m².

The surface roughness of the electrophotographic photosensitive member can be adjusted by appropriately selecting the feed speed of the polishing sheet 2-1, the pressing pressure of the backup roller 2-3, the type of the abrasive grain of the polishing sheet, the film thickness of the binder resin of the polishing sheet, the thickness of the base material, and the like.

### <Measurement of Maximum Height Rmax in JIS B06011982>

The surface roughness of the electrophotographic photosensitive member can be measured by a known unit. Examples thereof include the following units.

The examples include: a surface-roughness meter such as surface-roughness measuring instrument, Surfcorder SE3500 type, manufactured by Kosaka Laboratory Ltd.; non-contact three-dimensional surface measuring instrument, Micromap 557N, manufactured by Mitsubishi Chemical Systems, Inc.; and a microscope which can obtain a three-dimensional shape, such as ultra-deep shape measurement microscopes, VK-8550 and VK-9000, manufactured by Keyence Corporation.

From the viewpoint of the cleaning property, it is preferable that the maximum height Rmax of the surface roughness obtained by these units is 2 μm or smaller.

### <Process Cartridge and Electrophotographic Apparatus>

The electrophotographic photosensitive member of the present disclosure may be one of components of a process cartridge or an electrophotographic apparatus. The process cartridge includes: integrally supporting the electrophotographic photosensitive member described hitherto, and at least one unit selected from the group consisting of a charging unit, a developing unit, a transfer unit, and a cleaning unit; and being freely attachable to and detachable from a main body of an electrophotographic apparatus. In addition, the electrophotographic apparatus includes the electrophotographic photosensitive member described hitherto, the charging unit, an exposure unit, the developing unit and the transfer unit.

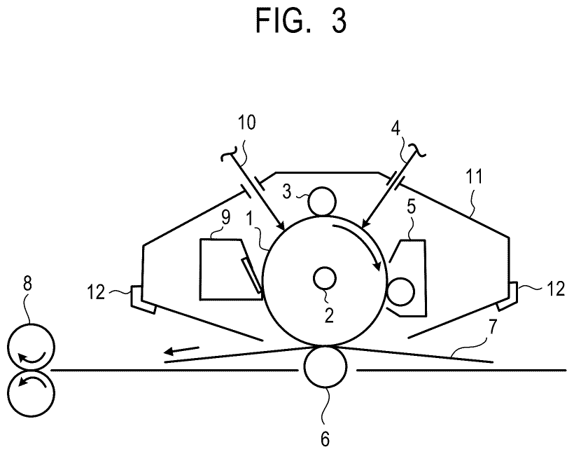

FIG. 3 illustrates one example of a schematic configuration of the electrophotographic apparatus including the process cartridge equipped with the electrophotographic photosensitive member.

A cylindrical (drum-shaped) electrophotographic photosensitive member 1 is rotationally driven around a shaft 2 in a direction of the arrow at a predetermined peripheral velocity (process speed). The surface of the electrophotographic photosensitive member 1 is electrostatically charged to a predetermined positive or negative potential by a charging unit 3, in a rotation process. For information, in FIG. 3, a roller charging system by a roller type charging member is illustrated, but a charging system such as a corona charging system, a proximity charging system or an injection charging system may also be adopted. The surface of the electrostatically charged electrophotographic photosensitive member 1 is irradiated with exposure light 4 emitted from an exposure unit (not illustrated), and an electrostatic latent image corresponding to objective image information is formed on the surface. The exposure light 4 is light that is intensity-modulated corresponding to time-series electric digital image signals of objective image information, and is output, for example, from the image exposure unit such as slit exposure or laser beam scanning exposure. The electrostatic latent image formed on the surface of the electrophotographic photosensitive member 1 is developed (normally developed or reversely developed) by a toner accommodated in a developing unit 5, and a toner image is formed on the surface of the electrophotographic photosensitive member 1. The toner image formed on the surface of the electrophotographic photosensitive member 1 is transferred onto a transfer material 7 by a transfer unit 6. At this time, a bias voltage having a polarity opposite to that of a charge held by the toner is applied to the transfer unit 6 from a bias power supply (not illustrated). In addition, when the transfer material 7 is paper, the transfer material 7 is taken out from a paper feeding unit (not illustrated), and is fed to a gap between the electrophotographic photosensitive member 1 and the transfer unit 6 in synchronization with the rotation of the electrophotographic photosensitive member 1. The transfer material 7 onto which the toner image has been transferred from the electrophotographic photosensitive member 1 is separated from the surface of the electrophotographic photosensitive member 1, is conveyed to a fixing unit 8, is subjected to a fixing process of the toner image, and is thereby printed out to the outside of the electrophotographic apparatus, as an image formed product (print or copy). The electrophotographic apparatus may include a cleaning unit 9 for removing an attached substance such as a toner remaining on the surface of the electrophotographic photosensitive member 1 after transfer. Alternatively, the cleaning unit may not be separately provided, but a so-called cleanerless system may be used that removes the above attached substance by the developing unit or the like. In the present disclosure, the process cartridge can be formed by accommodating a plurality of components selected from among the components such as the above electrophotographic photosensitive member 1, the charging unit 3, the developing unit 5 and the cleaning unit 9, in a vessel, and integrally supporting the components. In addition, the process cartridge can be configured to be freely attachable to and detachable from the main body of the electrophotographic apparatus. For example, the process cartridge is configured in the following way. A cartridge is structured by integrally supporting at least one selected from the group consisting of the charging unit 3, the developing unit 5 and the cleaning unit 9, together with the electrophotographic photosensitive member 1. This cartridge can be made into the process cartridge 11 which is freely attachable to and detachable from the main body of the electrophotographic apparatus, with the use of a guide unit 12 such as a rail of the main body of the electrophotographic apparatus. The electrophotographic apparatus may have a diselectrifying mechanism that subjects the surface of the electrophotographic photosensitive member 1 to a diselectrifying process by pre-exposure light 10 emitted from a pre-exposure unit (not illustrated). In addition, the guide unit 12 such as the rail may also be provided in order to detachably attach the process cartridge 11 of the present disclosure to the main body of the electrophotographic apparatus. The electrophotographic apparatus of the present disclosure includes: the electrophotographic photosensitive member 1; and at least one unit selected from the group consisting of the charging unit 3, the exposure unit, the developing unit 5 and the transfer unit 6.

The electrophotographic photosensitive member of the present disclosure can be used in a laser beam printer, an LED printer, a copying machine, a facsimile machine, a combined machine thereof and the like.

According to one aspect of the present disclosure, an electrophotographic photosensitive member can be provided that is excellent in the cleaning property and the durability and has a reduced residual potential.

### EXAMPLES

The present disclosure will be described in more detail below with reference to Examples and Comparative Examples, but the invention is not limited thereto. Herein, “part(s)” in the description of the following Examples is based on mass unless otherwise specified.

### <Surface Treatment of Vinyl Resin Particle>

The vinyl resin particles surface-treated with the compound represented by the above formula (A) or (B) were obtained by the following methods, respectively.

### (Particle 1)

Five parts of styrene-acrylic resin particles having an average primary particle size of 150 nm, 15 parts of pure water, 15 parts of hexane, and 10 parts of methanol were added into a glass flask equipped with a stirrer, a thermostatic chamber and a thermometer, and the mixture was heated to 50° C. while being stirred; and then one part of dimethoxydiphenylsilane was added thereto, and the resultant was stirred for 4 hours in a state of being kept at 50° C. After that, the mixed liquid was centrifuged, and the separated precipitate was washed with ethanol, and dried for 4 hours at a temperature of 50° C. at a state of a reduced pressure of 1000 Pa or lower; and thereby a particle 1 was obtained which was the surface-treated vinyl resin particle.

### (Particles 2 to 10)

Particles 2 to 10 were obtained in the same way as the particle 1, except that the particle type, the surface treatment agent and the surface treatment time were changed to those shown in Table 1, in the treatment of the particle 1.

TABLE 1

| | | Average | | |
|---|---|---|---|---|
| | | primary | | Surface |
| | Particle | particle | | treatment |
| Particle | type | size [nm] | Surface treatment agent | time [h] |
| Particle | Styrene | 150 | Dimethoxydiphenylsilane | 4 |
| 1 | acrylic | | | |
| Particle | Styrene | 150 | Dimethoxydimethylsilane | 4 |
| 2 | acrylic | | | |
| Particle | Styrene | 150 | Hexamethyl disilazane | 4 |
| 3 | acrylic | | | |
| Particle | Styrene | 150 | Dimethoxydiphenylsilane | 4 |
| 4 | | | | |
| Particle | Styrene | 150 | Dimethoxydiphenylsilane | 0.5 |
| 5 | acrylic | | | |
| Particle | Styrene | 150 | Dimethoxydiphenylsilane | 7 |
| 6 | acrylic | | | |
| Particle | Styrene | 150 | Dimethoxydiphenylsilane | 0.2 |
| 7 | acrylic | | | |
| Particle | Styrene | 150 | Dimethoxydiphenylsilane | 8 |
| 8 | acrylic | | | |
| Particle | Styrene | 150 | No treatment | 0 |
| 9 | acrylic | | | |
| Particle | Silica | 150 | Dimethoxydiphenylsilane | 4 |
| 10 | | | | |

### <Production of Electrophotographic Photosensitive Member>

### Example 1-1

### (Support 1)

A cylindrical aluminum cylinder (JIS-A3003, aluminum alloy, having outer diameter of 30.6 mm, length of 370 mm and thickness of 1 mm) was subjected to cutting work and the resultant cylinder was used as a support (electroconductive support). Ultrasonic cleaning in a cleaning liquid containing a detergent (trade name: Chemicol CT, produced by Tokiwa Chemical Industries Co., Ltd.) dissolved in pure water was performed, and then the cleaning liquid was washed away; and further ultrasonic cleaning in pure water was performed and degreasing treatment was performed, to obtain a support 1.

### (Undercoat Layer 1)

One hundred parts of zinc oxide particle (specific surface area: 19 m²/g, and powder resistance: 4.7×10⁶Ω·cm) was mixed with 500 parts of toluene while being stirred; and to this mixture, 0.8 parts of a silane coupling agent (compound name: N-2-(aminoethyl)-3-aminopropylmethyldimethoxy silane, and trade name: KBM602, produced by Shin-Etsu Chemical Co., Ltd.) was added, and the mixture was stirred for 6 hours. After that, toluene was distilled off under reduced pressure, and the resultant was heated and dried at 130° C. for 6 hours; and a surface-treated zinc oxide particle A was obtained.

Subsequently, as a polyol, 15 parts of butyral (trade name: BM-1, Sekisui Chemical Co., Ltd.), and 15 parts of blocked isocyanate (trade name: Duranate TPA-B80E, non-volatile content of 80% by mass, produced by Asahi Kasei Chemicals Corp.) were dissolved in a mixed solvent of 73.5 parts of methyl ethyl ketone and 73.5 parts of 1-butanol. To this solution, 80.8 parts of the surface-treated zinc oxide particle A and 0.81 parts of 2,3,4-trihydroxybenzophenone (produced by Tokyo Chemical Industry Co., Ltd.) were added, and the mixture was dispersed in a sand mill apparatus which used glass beads having a diameter of 0.8 mm, under an atmosphere of 23±3° C. for 3 hours.

After the dispersion treatment, 0.01 parts of silicone oil (trade name: SH28PA, produced by Dow Corning Toray Co., Ltd. (old: Dow Corning Toray Silicone Co., Ltd.)), 5.6 parts of a crosslinked polymethyl methacrylate (PMMA) particle (trade name: Techpolymer SSX-103, produced by Sekisui Kasei Co., Ltd., and average size of primary particles: 3 μm) were added thereto, the mixture was stirred, and a coating liquid for an undercoat layer was prepared.

The above support 1 was dip-coated with the obtained coating liquid for the undercoat layer to have a coating film formed thereon, the coating film was dried at 160° C. for 30 minutes, and an undercoat layer 1 was formed which had a film thickness of 18 μm.

### (Charge Generation Layer 1)

Four parts of hydroxygallium phthalocyanine crystal (charge generation substance) having a form of a crystal which had strong peaks at 7.4° and 28.1° at a Bragg angle of 20±0.2° in CuKα, characteristic X-ray diffraction, and 0.04 parts of a chemical compound represented by the following formula (1) were added to a liquid which was obtained by dissolving 2 parts of polyvinyl butyral (trade name: S-LEC BX-1, produced by Sekisui Chemical Co., Ltd.) in 100 parts of cyclohexanone. After that, the resultant liquid was subjected to dispersion treatment in a sand mill which used glass beads having a diameter of 1 mm, in an atmosphere of 23±3° C. for 1 hour, and after the dispersion treatment, 100 parts of ethyl acetate was added thereto; and a coating liquid for the charge generation layer was prepared.

An undercoat layer 1 was dip-coated with the coating liquid for the charge generation layer, and the obtained coating film was dried at 90° C. for 10 minutes; and thereby, a charge generation layer 1 was formed which had a film thickness of 0.15 μm.

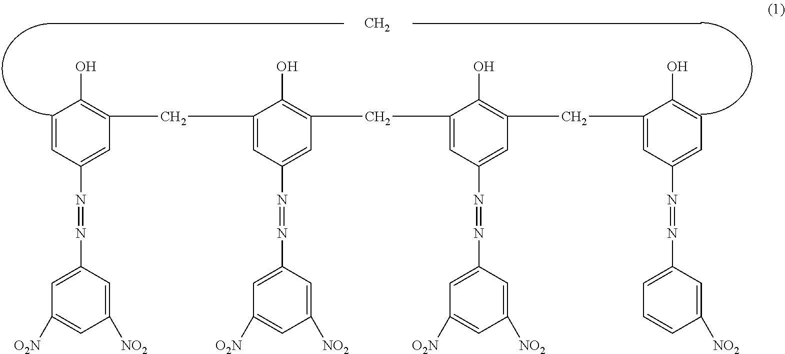

### (Charge Transport Layer 1)

A coating liquid for the charge transport layer was prepared by dissolving 60 parts of a compound represented by the following formula (2), 30 parts of a compound represented by the following formula (3), 10 parts of a compound represented by the following formula (4), 100 parts of a bisphenol Z type polycarbonate resin (trade name: Iupilon Z400, produced by Mitsubishi Engineering-Plastics Corporation), and 0.2 parts of polycarbonate (viscosity average molecular weight Mv: 20000) having a structural unit represented by the following formula (5), into a mixed solvent of 272 parts of o-xylene, 256 parts of methyl benzoate, and 272 parts of dimethoxymethane.

The above charge generation layer 1 was dip-coated with this coating liquid for the charge transport layer to have a coating film formed thereon, and the obtained coating film was dried at 115° C. for 50 minutes; and a charge transport layer 1 was formed which had a film thickness of 18 μm.

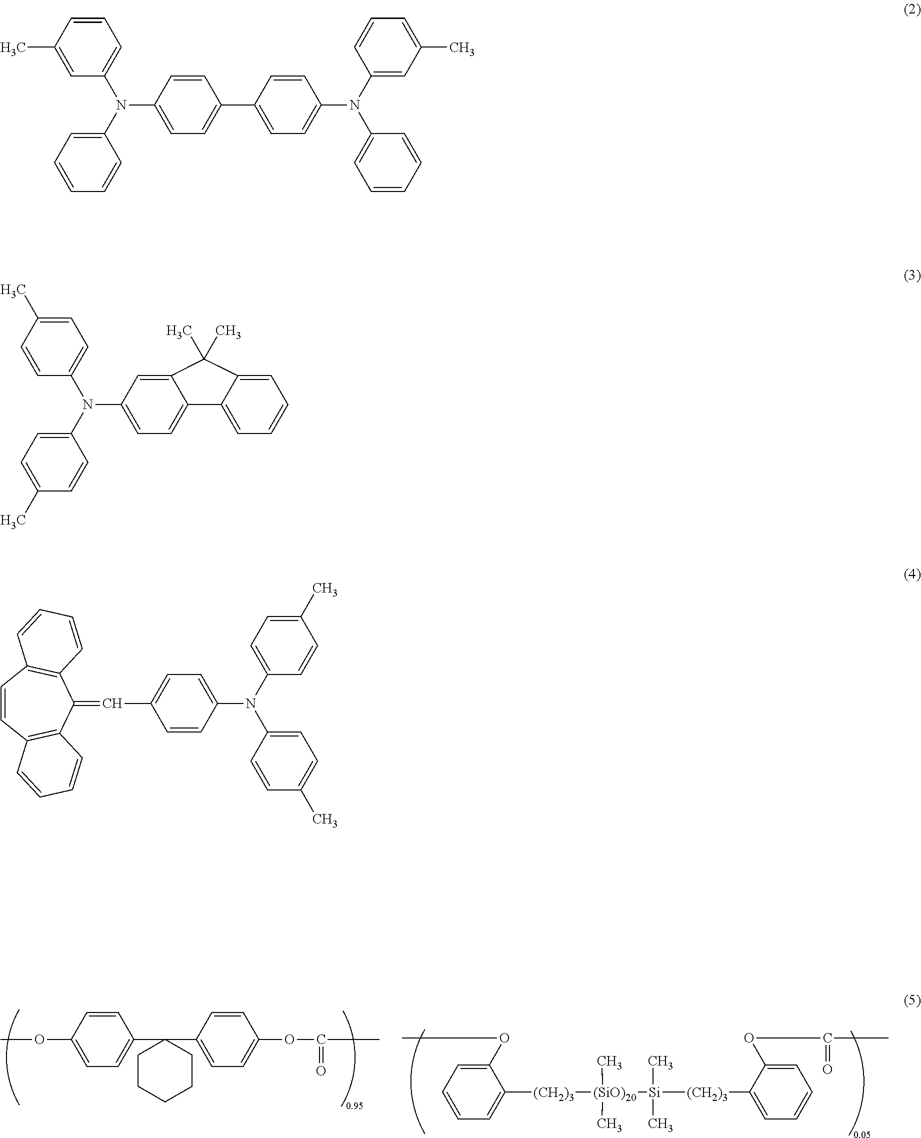

In the formula (5), 0.95 and 0.05 represent a molar ratio (copolymerization ratio) between two structural units.

### (Protective Layer 1)

Forty parts of the particle 1 which was prepared as described above were added to 100 parts of 1-propanol. Then, the mixture was passed through a high-pressure dispersing machine (trade name: Microfluidizer M-110EH, manufactured by Microfluidics Co. Ltd. U.S.), and a dispersion liquid of particles 1 was obtained.

To the obtained dispersion liquid of the particle 1, 97.3 parts of a charge transporting compound represented by the following formula (6) and 100 parts of 1-propanol were added. After that, the resultant mixture was filtered through a polyflon filter (trade name: PF-040, manufactured by Advantec Toyo Kaisha, Ltd.), and a dispersion liquid of particles 1 (coating liquid for protective layer) was prepared.

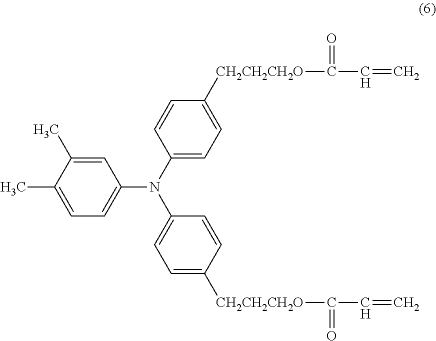

A charge transport layer was dip-coated with this coating liquid for the protective layer to have a coating film formed thereon, and the obtained coating film was dried at 40° C. for 5 minutes. After drying, the coating film was irradiated with an electron beam under a nitrogen atmosphere, under conditions of an acceleration voltage of 70 kV and an absorption dose of 15 kGy, for 1.6 seconds. After that, the coating film was subjected to heat treatment under a nitrogen atmosphere, under the condition that the temperature of itself became 135° C., for 15 seconds. Note that an oxygen concentration was 15 ppm in a period from the irradiation with an electron beam to the heat treatment for 15 seconds. Next, the coating film was naturally cooled to a temperature of 25° C. in the atmosphere, and then was subjected to heat treatment for 1 hour under the condition that the coating film became 105° C.; and a surface layer (protective layer 1) was formed which had a film thickness of 5 μm.

The silicon content was measured by the previously described method for measuring the silicon content, and was 0.1%.

Thus, an electrophotographic photosensitive member was produced which had a support and a surface layer before the surface is polished.

### <Surface Working of Electrophotographic Photosensitive Member>

(Polishing of electrophotographic photosensitive member before surface polishing)

The surface of the electrophotographic photosensitive member was polished, before the surface shape was formed. The surface was polished under the following conditions, with the use of the polishing apparatus illustrated in FIG. 2.
Feed speed of the polishing sheet; 400 mm/min
Number of rotations of electrophotographic photosensitive member; 450 rpm
Push-in distance of the electrophotographic photosensitive member into the backup roller; 3.5 mm
Rotation directions of polishing sheet and electrophotographic photosensitive member; with
Backup roller; outer diameter of 100 mm, and asker C hardness of 25 The polishing sheet A to be mounted on the polishing apparatus was produced by the mixture of the polishing abrasive grains which are used in GC3000 and GC2000 produced by Riken Corundum Co., Ltd.
GC3000 (where surface roughness Ra of polished sheet is 0.83 μm)
GC2000 (where surface roughness Ra of polished sheet is 1.45 μm)
Polishing sheet A (where surface roughness Ra of polished sheet is 1.12 μm)

A period of time of polishing with the use of the polishing sheet A was determined to be 20 seconds.

### (Measurement of Polishing Depth L (μm))

The maximum height Rmax of the electrophotographic photosensitive member after having been polished was measured according to JIS B06011982 with the use of a surface roughness measuring instrument Surfcorder SE3500 which is manufactured by Kosaka Laboratory Co., Ltd. The measurement conditions were set as follows. Arbitrary three portions in a range of a 5 mm square of the electrophotographic photosensitive member after having been polished were subjected to the measurement, and the average value was adopted as a polishing depth L (μm). The polishing depth L of the electrophotographic photosensitive member after the surface was polished was 0.75 μm. Furthermore, in Examples 1-2 to 1-12 which would be described later, the polishing depths L of the electrophotographic photosensitive members which were subjected to the surface working were all 0.75 μm.

### (Measurement Conditions)

Detector: R2 μm
Probe: diamond needle of 0.7 mN
Filter: 2CR
Cut-off value: 0.08 mm
Measurement length: 2.5 mm
Feed speed: 0.1 mm

### Examples 1-2 to 1-12, and Comparative Examples 1-1 to 1-3

An electrophotographic photosensitive member was produced in the same way as in Example 1-1 except that when the protective layer 1 was formed, the particle and the parts by mass of the added particle were changed as shown in Table 2.

The content of silicon atoms in a film of the surface layer is shown together in Table 2.

TABLE 2

| | | Parts by | Silicon |
|---|---|---|---|
| | | mass of added | atomic weight |
| | Particle | particle [part] | in film [%] |
| Example 1-1 | Particle 1 | 20 | 0.1000 |
| Example 1-2 | Particle 2 | 20 | 0.1000 |
| Example 1-3 | Particle 3 | 20 | 0.1000 |
| Example 1-4 | Particle 4 | 20 | 0.1000 |
| Example 1-5 | Particle 1 | 1 | 0.0050 |
| Example 1-6 | Particle 1 | 30 | 0.1500 |
| Example 1-7 | Particle 1 | 0.1 | 0.0010 |
| Example 1-8 | Particle 1 | 31 | 0.1550 |
| Example 1-9 | Particle 5 | 20 | 0.0010 |
| Example 1-10 | Particle 6 | 20 | 0.3000 |
| Example 1-11 | Particle 7 | 20 | 0.0001 |
| Example 1-12 | Particle 8 | 20 | 0.3100 |
| Comparative | Particle 9 | 20 | 0.0000 |
| Example 1-1 | | | |
| Comparative | Particle 10 | 20 | 0.1000 |
| Example 1-2 | | | |
| Comparative | — | 0 | 0.0000 |
| Example 1-3 | | | |

### Example 2-1

### (Support 2)

A cylindrical aluminum cylinder (JIS-A3003, aluminum alloy, having outer diameter of 30 mm, length of 357.5 mm and thickness of 0.7 mm) was subjected to cutting work and the resultant cylinder was used as a support (electroconductive support). Ultrasonic cleaning in a cleaning liquid containing a detergent (trade name: Chemicol CT, produced by Tokiwa Chemical Industries Co., Ltd.) dissolved in pure water was performed, and then the cleaning liquid was washed away; and further ultrasonic cleaning in pure water was performed and degreasing treatment was performed, to obtain a support 2.

### (Undercoat Layer 2)

Sixty parts of a zinc oxide particle (average particle size: 70 nm, and specific surface area: 15 m²/g) was mixed with 500 parts of tetrahydrofuran while being stirred; and to this mixture, 0.75 parts of a silane coupling agent (compound name: N-2-(aminoethyl)-3-aminopropyltrimethoxy silane, and trade name: KBM603, produced by Shin-Etsu Chemical Co., Ltd.) was added, and the mixture was stirred for 2 hours. After that, tetrahydrofuran was distilled off under reduced pressure, and the resultant was heated and dried at 120° C. for 3 hours; and a surface-treated zinc oxide particle was obtained.

Subsequently, 25 parts of butyral (trade name: BM-1, produced by Sekisui Chemical Co., Ltd.) as a polyol, and 22.5 parts of a blocked isocyanate (trade name: Sumidule BL- 3173, produced by Sumika Covestro Urethane Co., Ltd.) were dissolved in 142 parts of methyl ethyl ketone. To this solution, 100 parts of the surface-treated zinc-oxide particle and 1 part of alizarin were added, and the mixture was dispersed for 5 hours in a sand mill using glass beads having a diameter of 1 mm.

After the dispersion treatment, 0.008 parts of dioctyl tin dilaurate and 6.5 parts of a silicone resin particle (Tospearl 145, produced by GE Toshiba Silicone Co., Ltd.) were added to the above mixture, and the resultant mixture was stirred; and a coating liquid for an undercoat layer was prepared.

The above support 2 was dip-coated with the obtained coating liquid for the undercoat layer to have a coating film formed thereon, the coating film was dried at 190° C. for 24 minutes, and an undercoat layer 2 was formed which had a film thickness of 15 μm.

### (Charge Generation Layer 2)

Next, 15 parts of a chlorogallium phthalocyanine crystal having strong diffraction peaks at least at 7.4°, 16.6°, 25.5° and 28.3° at a Bragg angle (20±0.2°) in CuKα, characteristic X-rays, 10 parts of a vinyl chloride-vinyl acetate copolymer resin (VMCH, produced by Nippon Union Carbide), and 300 parts of n-butyl alcohol are mixed; and the mixture was subjected to dispersion treatment in a sand mill which used glass beads having a diameter of 1 mm, for 4 hours; and a coating liquid for a charge generation layer was prepared.

The undercoat layer 2 was dip-coated with the coating liquid for the charge generation layer, and the obtained coating film was dried at 150° C. for 5 minutes; and thereby, a charge generation layer 2 was formed which had a film thickness of 0.2 μm.

### (Charge Transport Layer 2)

Next, 10 parts of the previously described surface-treated particles 1 and 50 parts of tetrahydrofuran were mixed while the mixture was stirred and the liquid temperature was kept at 20° C., for 48 hours, and a preparation liquid A was obtained.

Next, 40 parts of N,N′-bis(3-methylphenyl)-N,N′-diphenylbenzidine, 10 parts of a compound represented by the following formula (7), 75 parts of a bisphenol Z type polycarbonate resin (viscosity average molecular weight of 40,000) and 2.0 parts of 2,6-di-t-butyl-4-methylphenol serving as an antioxidizing agent were mixed, and the mixture was mixed with and dissolved into 250 parts of tetrahydrofuran; and a preparation liquid B was obtained.

The preparation liquid A was added to the preparation liquid B, and the mixture was stirred and mixed, and was passed through a high-pressure dispersing machine (trade name: Microfluidizer M-110EH, manufactured by Microfluidics Co., Ltd. U.S.); and a dispersion liquid was obtained.

After that, the resultant mixture was filtered through a polyflon filter (trade name: PF-040, manufactured by Advantec Toyo Kaisha, Ltd.), and a coating liquid for a charge transport layer was prepared.

The charge generation layer was dip-coated with this coating liquid for the charge transport layer to have a coating film formed thereon, and the obtained coating film was dried at 150° C. for 40 minutes; and a charge transport layer was formed which had a film thickness of 40 μm.

Thus, an electrophotographic photosensitive member was produced.

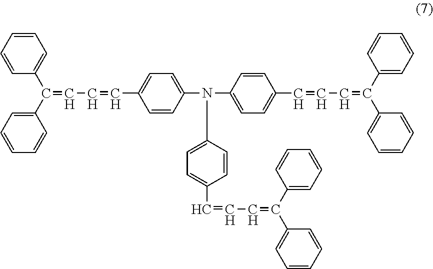 [SMILES: C(=Cc1ccc(N(c2ccc(C=CC=C(c3ccccc3)c3ccccc3)cc2)c2ccc(C=CC=C(c3ccccc3)c3ccccc3)cc2)cc1)C=C(c1ccccc1)c1ccccc1]

### Examples 2-2 to 2-12, and Comparative Examples 2-1 to 2-3

An electrophotographic photosensitive member was produced in the same way as in Example 2-1, except that when the charge transport layer 2 was formed, the particle and the parts by mass of the added particle were changed as shown in Table 3.

The content of silicon atoms in a film of the surface layer is shown in Table 3.

TABLE 3

| | | Parts by | Silicon |
|---|---|---|---|
| | | mass of added | atomic weight |
| | Particle | particle [part] | in film [%] |
| Example 2-1 | Particle 1 | 20 | 0.1000 |
| Example 2-2 | Particle 2 | 20 | 0.1000 |
| Example 2-3 | Particle 3 | 20 | 0.1000 |
| Example 2-4 | Particle 4 | 20 | 0.1000 |
| Example 2-5 | Particle 1 | 1 | 0.0050 |
| Example 2-6 | Particle 1 | 30 | 0.1500 |
| Example 2-7 | Particle 1 | 0.1 | 0.0010 |
| Example 2-8 | Particle 1 | 31 | 0.1550 |
| Example 2-9 | Particle 5 | 20 | 0.0010 |
| Example 2-10 | Particle 6 | 20 | 0.3000 |
| Example 2-11 | Particle 7 | 20 | 0.0001 |
| Example 2-12 | Particle 8 | 20 | 0.3100 |
| Comparative | Particle 9 | 20 | 0.0000 |
| Example 2-1 | | | |
| Comparative | Particle 10 | 20 | 0.1000 |
| Example 2-2 | | | |
| Comparative | — | 0 | 0.0000 |
| Example 2-3 | | | |

### <Evaluation of Electrophotographic Photosensitive Member>

The electrophotographic photosensitive members which were produced from the electrophotographic photosensitive members obtained in Examples 1-1 to 1-12 and 2-1 to 2-12 and Comparative Examples 1-1 to 1-3 and 2-1 to 2-3 were evaluated in the following way.

### [Evaluation Apparatus 1-1]

The electrophotographic photosensitive members produced in Examples 1-1 to 1-12 and Comparative Examples 1-1 to 1-3 were mounted on an image PRESS C800 (trade name), which was a copying machine manufactured by Canon Inc., and were evaluated.

Specifically, the above evaluation apparatus was installed in a normal-temperature and normal-humidity environment of a temperature of 23° C. and a relative humidity of 50% RH; the produced electrophotographic photosensitive member was mounted in a process cartridge for a magenta color; the resultant process cartridge was mounted in a station for the process cartridge for magenta; and the electrophotographic photosensitive member was evaluated.

### [Evaluation Apparatus 1-2]

The electrophotographic photosensitive members produced in Examples 1-1 to 1-12 and Comparative Examples 1-1 to 1-3 were each mounted on a modified machine of the image PRESS C800 (trade name), which was a copying machine manufactured by Canon Inc., and were evaluated. The charging unit of the modified machine is a charging unit having a system of applying a voltage which is obtained by superimposing an AC voltage on a DC voltage to a roller type of a contact charging member (charging roller); and the exposure unit is an exposure unit of a laser image exposure system (wavelength of 680 nm).

Specifically, the above evaluation apparatus was installed in a normal-temperature and normal-humidity environment of a temperature of 23° C. and a relative humidity of 50% RH; the produced electrophotographic photosensitive member was mounted in a process cartridge for a magenta color; the resultant process cartridge was mounted in a station for the process cartridge for magenta; and the electrophotographic photosensitive member was evaluated.

As for the charging conditions, a charging potential and an exposure amount of the exposure unit were adjusted so that the charging potential became −800 V and the exposure potential became −300 V.

For information, a surface potential of the electrophotographic photosensitive member was measured by taking out a developing cartridge from the above evaluation apparatus, and inserting a potential measuring apparatus into the developing cartridge. The potential measuring apparatus is configured in such a way that a potential measuring probe (trade name: model 6000B-8, manufactured by TREK Japan) is arranged at a developing position of the developing cartridge. In addition, a position of the potential measuring probe with respect to the electrophotographic photosensitive member was set at the center of the electrophotographic photosensitive member in the generatrix direction and at such a position that the gap from the surface of the electrophotographic photosensitive member became 3 mm. Furthermore, the potential of the central portion of the electrophotographic photosensitive member was measured with the use of a surface electrometer (trade name: model 344, manufactured by TREK Japan).

### [Evaluation Apparatus 2-1]

The electrophotographic photosensitive members produced in Examples 2-1 to 2-12 and Comparative Examples 2-1 to 2-3 were each mounted on a modified machine of an image RUNNER iR-ADV C3835F (trade name), which was a copying machine manufactured by Canon Inc., and were evaluated.

Specifically, the above evaluation apparatus was installed in a normal-temperature and normal-humidity environment of a temperature of 23° C. and a relative humidity of 50% RH; the produced electrophotographic photosensitive member was mounted in a process cartridge for a cyan color; the resultant process cartridge was mounted in a station for the process cartridge for cyan; and the electrophotographic photosensitive member was evaluated.

### [Evaluation Apparatus 2-2]

The electrophotographic photosensitive members produced in Examples 2-1 to 2-12 and Comparative Examples 2-1 to 2-3 were mounted on a modified machine of the image RUNNER iR-ADV C3835F (trade name), which was the copying machine manufactured by Canon Inc., and were evaluated.

Specifically, the above evaluation apparatus was installed in a normal-temperature and normal-humidity environment of a temperature of 23° C. and a relative humidity of 50% RH; the produced electrophotographic photosensitive member was mounted in a process cartridge for a cyan color; the resultant process cartridge was mounted in a station for the process cartridge for cyan; and the electrophotographic photosensitive member was evaluated.

As for the charging conditions, a charging potential and an exposure amount of the exposure unit were adjusted so that the charging potential became −700 V and the exposure potential became −200 V.

For information, a surface potential of the electrophotographic photosensitive member was measured by taking out a developing cartridge from the above evaluation apparatus, and inserting a potential measuring apparatus into the developing cartridge. The potential measuring apparatus was configured in such a way that a potential measuring probe (trade name: model 6000B-8, manufactured by TREK Japan) was arranged at a developing position of the developing cartridge; and a position of the potential measuring probe with respect to the electrophotographic photosensitive member was set at the center of the electrophotographic photosensitive member in the generatrix direction and at such a position that the gap from the surface of the electrophotographic photosensitive member became 3 mm. Furthermore, the potential of the central portion of the electrophotographic photosensitive member was measured with the use of a surface electrometer (trade name: model 344, manufactured by TREK Japan).

### (Evaluation of Amount of Scraping)

The amount of scraping was evaluated with the use of the above evaluation apparatus 1-1 and evaluation apparatus 2-1.

An initial total film thickness of the electrophotographic photosensitive member was measured at five points at equal intervals in the generatrix direction of the electrophotographic photosensitive member, with an eddy current film thickness meter (Fischerscope, manufactured by Fischer Instruments K. K.), and an average value of the five points was determined to be the film thickness before a durability test.

Next, a continuous durability test of 50000 sheets was performed with an A4 size of a test chart having an image ratio of 5%. The film thickness of the electrophotographic photosensitive member after the durability test was measured in the same way as the initial film thickness, and the difference in film thickness before and after the durability test was determined to be the amount of scraping (μm). As the amount of scraping becomes smaller, the abrasion resistance and the cleaning property become more excellent. The results are shown in Table 4 and Table 5.

### (Residual Potential Evaluation)

The residual potential was evaluated by measuring the residual potential with the use of the above evaluation apparatus 1-2 and the evaluation apparatus 2-2. An applied bias was set so that a dark portion potential of the non-exposed portion of the electrophotographic photosensitive member became −600 V, and the light quantity of the laser light was set so as to become 0.313 μJ/cm². The residual potential was determined by repeating light exposure corresponding to an A3 size for five sheets to thereby remove electricity by receiving the pre-exposure, and then immediately measuring a potential of the first round. In Example 1-1, the residual potential was 10 V As the value of the residual potential becomes smaller, the result is more satisfactory. The results of the evaluation in this way are shown in Table 4 and Table 5.

TABLE 4

| | Amount of scraping | Residual |
|---|---|---|
| | [μm/ 50K sheets] | potential [V] |
| Example 1-1 | 1.00 | 10 |
| Example 1-2 | 1.00 | 23 |
| Example 1-3 | 1.00 | 26 |
| Example 1-4 | 1.50 | 16 |
| Example 1-5 | 1.15 | 7 |
| Example 1-6 | 0.95 | 18 |
| Example 1-7 | 1.70 | 5 |
| Example 1-8 | 0.90 | 22 |
| Example 1-9 | 1.00 | 16 |
| Example 1-10 | 1.00 | 15 |
| Example 1-11 | 1.00 | 22 |
| Example 1-12 | 1.00 | 24 |
| Comparative | 1.00 | 56 |
| Example 1-1 | | |
| Comparative | 5.00 | 12 |
| Example 1-2 | | |
| Comparative | 5.00 | 4 |
| Example 1-3 | | |

TABLE 5

| | Amount of scraping | Residual |
|---|---|---|
| | [μm/ 50K sheets] | potential [V] |
| Example 2-1 | 14.0 | 40 |
| Example 2-2 | 14.0 | 51 |
| Example 2-3 | 14.0 | 56 |
| Example 2-4 | 20.0 | 48 |
| Example 2-5 | 16.0 | 36 |
| Example 2-6 | 12.0 | 47 |
| Example 2-7 | 20.0 | 35 |
| Example 2-8 | 11.0 | 48 |
| Example 2-9 | 14.0 | 48 |
| Example 2-10 | 14.0 | 38 |
| Example 2-11 | 14.0 | 51 |
| Example 2-12 | 14.0 | 56 |
| Comparative | 14.0 | 88 |
| Example 2-1 | | |
| Comparative | 30.0 | 40 |
| Example 2-2 | | |
| Comparative | 30.0 | 34 |
| Example 2-3 | | |

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-194624, filed Nov. 15, 2023, which is hereby incorporated by reference herein in its entirety.

What is claimed is:

1. An electrophotographic photosensitive member having a surface layer, wherein
the surface layer comprises a vinyl resin particle and a charge transport substance, and
the vinyl resin particle is surface-treated with at least one selected from the group consisting of: a compound represented by formula (A) and a compound represented by formula (B): 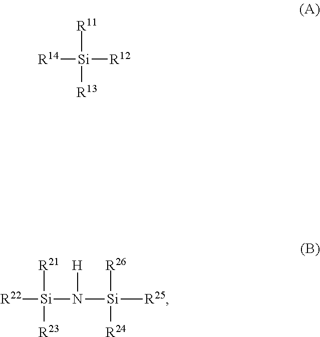
wherein in formula (A), R¹¹ to R¹⁴ each independently represent an alkyl group, a phenyl group, an alkoxy group or a halogen atom, provided that at least one of R¹¹ to R¹⁴ is an alkoxy group or a halogen atom, and at least one of R¹¹ to R¹⁴ is an alkyl group or a phenyl group; and
in formula (B), R²¹ to R²⁶ each independently represent an alkyl group or a phenyl group.

2. The electrophotographic photosensitive member according to claim 1, wherein two of R¹¹ to R¹⁴ in formula (A) are phenyl groups.

3. The electrophotographic photosensitive member according to claim 1, wherein the vinyl resin particle is of a styrene-acrylic resin.

4. The electrophotographic photosensitive member according to claim 1, wherein a content of the vinyl resin particle in the surface layer is 1% by mass or more and 30% by mass or less with respect to a total mass of the surface layer.

5. The electrophotographic photosensitive member according to claim 1, wherein a content of silicon atoms derived from the compound represented by formula (A) in the surface layer is 0.0010 atomic % or more and 0.3000 atomic % or less with respect to all atoms in the surface layer.

6. The electrophotographic photosensitive member according to claim 1, wherein the charge transport substance contains a compound represented by formula (C): 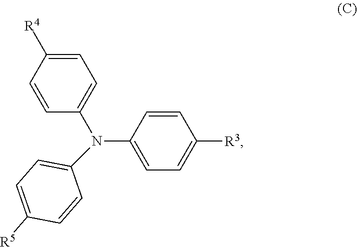
wherein R¹ and R² are each independently a hydrogen atom or a methyl group, and R³ is a linear or branched alkyl group having 1 to 5 carbon atoms, a methacryloyloxy group, or an acryloyloxy group.

7. The electrophotographic photosensitive member according to claim 1, wherein the surface layer is a polymer of a composition containing a compound represented by formula (D): 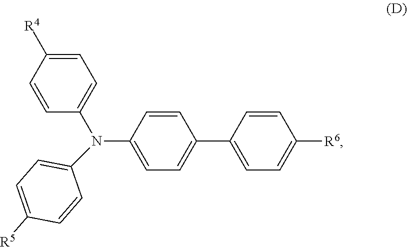
wherein R⁴ and R⁵ are each independently a hydrogen atom or a methyl group, and R⁶ is a methacryloyloxy group or an acryloyloxy group.

8. A process cartridge that integrally supports at least one unit selected from the group consisting of a charging unit, a developing unit, and a cleaning unit, and that is freely attachable to and detachable from a main body of an electrophotographic apparatus, wherein
the process cartridge comprises an electrophotographic photosensitive member,
the electrophotographic photosensitive member has a surface layer,
the surface layer comprises a vinyl resin particle and a charge transport substance, and
the vinyl resin particle is surface-treated with at least one selected from the group consisting of: a compound represented by formula (A) and a compound represented by formula (B): 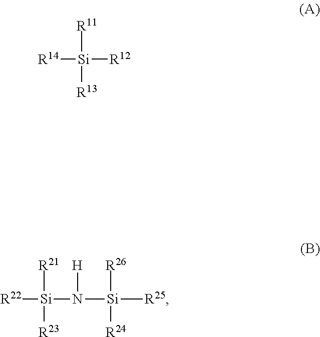
wherein in formula (A), R¹¹ to R¹⁴ each independently represent an alkyl group, a phenyl group, an alkoxy group or a halogen atom, provided that at least one of R¹¹ to R¹⁴ is an alkoxy group or a halogen atom, and at least one of R¹¹ to R¹⁴ is an alkyl group or a phenyl group; and
in formula (B), R²¹ to R²⁶ each independently represent an alkyl group or a phenyl group.

9. An electrophotographic apparatus comprising an electrophotographic photosensitive member, a charging unit, an image exposure unit, a developing unit and a transfer unit, wherein
the electrophotographic photosensitive member has a surface layer,
the surface layer comprises a vinyl resin particle and a charge transport substance, and
the vinyl resin particle is surface-treated with at least one selected from the group consisting of: a compound represented by formula (A) and a compound represented by formula (B): 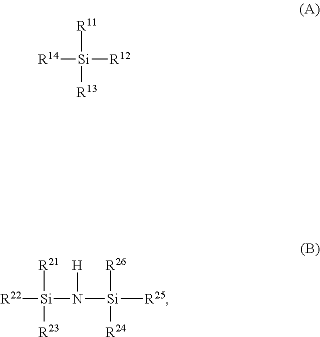
wherein in formula (A), R¹¹ to R¹⁴ each independently represent an alkyl group, a phenyl group, an alkoxy group or a halogen atom, provided that at least one of R¹¹ to R¹⁴ is an alkoxy group or a halogen atom, and at least one of R¹¹ to R¹⁴ is an alkyl group or a phenyl group; and
in formula (B), R²¹ to R²⁶ each independently represent an alkyl group or a phenyl group.
